(19) United States
(12) Patent Application Publication
(10) Pub. No.: US 2002/0124070 A1
(43) Pub. Date: Sep. 5, 2002

(54) System for providing related information of a network error event in a hand-held device

(76) Inventor: Eric A. Pulsipher, Ft Collins, CO (US)

Correspondence Address: HEWLETT-PACKARD COMPANY, Intellectual Property Administration, P.O. Box 272400, Fort Collins, CO, 80527-2400, US

(21) Appl. No.: 09/796,709

(22) Filed: Mar. 2, 2001

(51) Int. Cl. G06F 15/16; G06F 15/173

(52) U.S. Cl. 709/223; 709/217

(57) ABSTRACT

A system for providing related information of a network error event to a user in a hand-held device format. In one aspect, the present invention may include a desktop computer system executing a network management software (“NMS”), a hand-held formatter module and a hand-held device interface. The NMS provides a network manager (or administrator/user) the capability to manager, monitor, and/or diagnose a network. In response to a network error event, e.g., a faulty network card, disabled repeater, and the like, the NMS may be configured to generate a repair message, e.g., a trouble ticket, to notify the user of the network error event. The NMS may be further configured to gather related information such network wiring diagrams related to the location of the network error event and/or user, other events that have occurred in a temporally close time, repair checklists, and the like, in response to the repair message. The hand-held formatter module may be configured to convert the related information into a hand-held data format, e.g., PALM OS, POCKET PC, etc., for transfer to a hand-held device through the hand-held device interface.

### TECHNICAL FIELD

The invention relates to computer networks. More particularly, the invention relates to improving the ease of troubleshooting computer networks by providing related information of a network error event in a hand-held device data format.

### DESCRIPTION OF THE RELATED ART

Network communications have become a fundamental part of today's computing. It is not uncommon to find two or more computer systems working together to resolve computing issues such as simulations, modeling, forecasting, etc. In fact, networked computer systems working together have been so successful, users have been inclined to design and implement substantially larger networks.

As the networks grow larger, increasingly complex, and interface with a variety of diverse networks, it is the task of a network manager (or administrator or user) to keep track of the devices on the networks, to monitor performances and load, diagnose, and correct problems with the network.

To assist a network manager, network management software may be used in the management of a network. Conventional network management software (“NMS”) typically executes on a management device or node of the network. From the management node, the conventional NMS may be configured to determine a network topology, detect malfunctioning remote network devices or communication links, monitor network traffic, etc.

The NMS may be configured to respond to a network error event by generating a repair message (or trouble ticket) to notify a network manager. As part of the overall functionality, the NMS may be configured to detect network error events within the network or accept user-input about possible network errors. The network error event may be a break in the physical layer of the network, a malfunctioning network card, a slowdown in network traffic, and the like. The repair message (or trouble ticket) may include related information such as a reporting user, a user account, a location of the user, a description of the problem, etc.

A network manager may typically gather the related information of a network error event on the management node in response to receipt of a repair message. The network manager (or administrator) may display network wiring diagrams, access a troubleshooting database for related network error events, etc. The network manager may then take notes of the related information and proceed to a physical location in the network where the network error event may have occurred. At the physical location, the network manager may take status notes of the attempted resolution or the resolution of the network error event. Subsequently, the network manager returns to the management node to enter the status notes into the NMS and update the status of the repair message.

The above-mentioned technique for resolving network error events may be cumbersome and time-intensive. Taking handwritten notes from the NMS about the gathered related information may take a long period of time to jot down information related to a description of the network error event, network wiring diagrams, possible solutions to the network error event, etc., to resolve the network error event. The handwritten notes may be hastily written which may lead to additional delays in resolving the network error event. Furthermore, the handwritten notes may not contain sufficient information for the network manager to resolve the network error event. Accordingly, the above technique may lengthen the time in resolving the network error event, thereby increasing a frustration level for a reporting user and/or the network manager.

A possible solution may be to provide a laptop computer executing the NMS with a wireless interface. In this manner, the laptop computer may be brought to a location of where a network error event is occurring and receive network status updates on location. However, the location may be in a shielded room, which may block radio frequency transmissions. Accordingly, the wireless interface may not receive the network status updates and thus, the NMS may not provide the necessary related information for a network manager to resolve the network error event. Moreover, a network error event may occur in a cramped location, e.g., a wiring closet, a wire running within a ceiling, where a laptop, despite its relative small size, may be cumbersome to maneuver.

### SUMMARY OF INVENTION

In accordance with the principles of the present invention, a method for assisting network management includes parsing a received repair message and gathering related information in response to the parsing. The method further includes formatting the related information according to a hand-held data format into a formatted related information in response to a command and transferring the formatted related information to a hand-held device.

One aspect of the present invention provides for a system for assisting network management that includes at least one processor, a memory coupled to the at least one processor; and a hand-held data formatter. The hand-held data formatter resides in the memory and is executed by the at least one processor. The hand-held data formatter is configured to gather related information in response to parsing a received repair message and to format the related information into a hand-held related information in response to a command.

Another aspect of the present invention provides for a computer-readable storage medium on which is embedded one or more computer programs. The one or more computer programs containing instructions for parsing a received repair message and gathering related information in response to the parsing. The one or more computer programs further contain instructions for formatting the related information into a hand-held related information in response to a command, and transferring the hand-held related information to a hand-held device.

Additional advantages and novel features of the invention will be set forth in part, in the description which follows, and in part, will become apparent to those skilled in the art upon examination of the following or may be learned by practice of the invention. The advantages of the present invention may be realized and attained by means of instrumentalities and combinations particularly pointed in the appended claims.

### DESCRIPTION OF DRAWINGS

Features and advantages of the present invention will become apparent to those skilled in the art from the following description with reference to the drawings, in which:

FIG. 1 illustrates a block diagram of an exemplary embodiment of a hand-held formatter in accordance with the principles of the present invention;

FIG. 2 illustrates a block diagram of a computing platform in which an embodiment of the present invention may be implemented;

FIG. 3 illustrates a more detailed block diagram of a software architecture of an embodiment of the present invention;

FIG. 4 illustrates an exemplary embodiment of a data flow diagram of the hand-held data formatter as shown in FIG. 3;

FIG. 5 illustrates an exemplary embodiment of a user interface of the NMS to select the types of related information to be transferred;

FIG. 6 illustrates an exemplary flow diagram of a download operation in accordance with the principles of the present invention; and

FIG. 7 illustrates an exemplary flow diagram of a synchronization operation in accordance with the principles of the present invention.

### DETAILED DESCRIPTION OF THE PREFERRED EMBODIMENTS

For simplicity and illustrative purposes, the principles of the present invention are described by referring mainly to an exemplary embodiment thereof. Although the preferred embodiment of the invention may be practiced as a software system, one of ordinary skill in the art would readily recognize that the same principles are equally applicable to, and can be implemented in, a hardware system, and that any such variation would be within such modifications which do not depart from the true spirit and scope of the present invention.

In accordance with the principles of the present invention, a hand-held formatter system for providing related information of a network error event to a user in a hand-held device format is disclosed. In one aspect, the present invention may include a desktop computer system capable of executing a network management software (“NMS”), a handheld formatter module and a hand-held device interface. The NMS provides a network manager (or administrator/user) the capability to manage, monitor, and/or diagnose a network. In response to a network error event, e.g., a faulty network card, disabled repeater, or the like, the NMS may be configured to generate a repair message, e.g., a trouble ticket to notify the network manager of the network error event. The NMS may be configured to gather related information such network wiring diagrams related to the location of the network error event and/or user, other events that have occurred in a temporally close time, repair checklists, and the like, in response to the repair message.

The hand-held formatter module may be configured to convert the related information into a hand-held data format, e.g., PALM OS, POCKET PC, etc., for transfer to a hand-held device through the hand-held device interface.

According to another aspect of the present invention, the hand-held interface may be configured to interface with a hand-held device such as a personal digital assistant, a pocket personal computer, and the like. The hand-held device may further be configured to receive repair information, such as notes, status of the repair of the network error event, and the like from the network manager responding to the repair message. The hand-held device may be further configured to transfer the repair information to the NMS in response to the hand-held device synchronizing with the management node of the network manager. The NMS may further be configured to update the repair message with the repair information generated by the network manager in response to the synchronizing event.

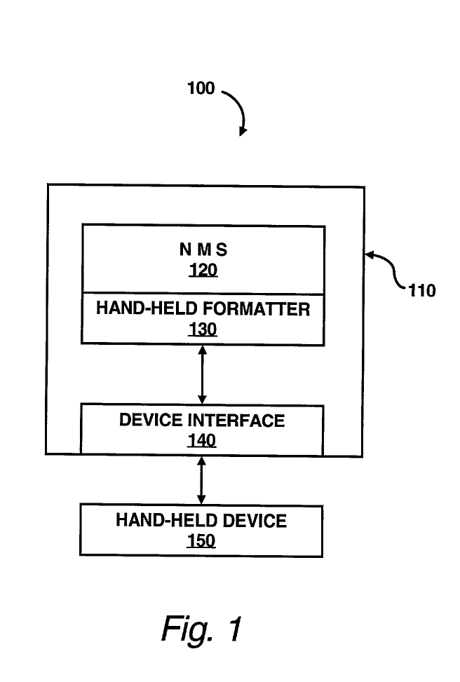

FIG. 1 illustrates a block diagram 100 of an exemplary embodiment of a hand-held formatter in accordance with the principles of the present invention executing on a management node 110. In particular, the management node 110 is configured to provide an execution platform for a network management software (“NMS”) 120. The management node 110 may be implemented by a personal computer, workstation, a client, a server or the like.

The NMS 120 may be configured to provide to the management node 110 the capability to monitor and maintain a network (not shown) through a network interface (not shown) of the management node 110. The NMS 120 is further configured to generate a repair message to a network manager (or administrator/user) in response to a network error event as part of the monitoring function of the NMS 120. The network error event may be a reduction in network throughput, a disabled network card, a physical break in the network cables/wires, and the like.

The NMS 120 is further configured to gather related information from the repair message to assist a network manager to diagnose and repair the network error event. The related information may include information such as a reporting user, a location of the reporting user, other network error events, etc.

The NMS 120 is further configured to forward the gathered related information to a hand-held device in the hand-held device data format in response to a command from a network manager. The command may be implemented as a menu option generated by the NMS 120, a command line prompt, and the like.

The NMS 120 is further configured to forward the gathered related information to a hand-held formatter 130. The hand-held formatter 130 is configured to convert the forwarded related information from the NMS data format to a hand-held device data format. The handheld device format may be compatible with PALM OS, POCKET PC, and the like.

After the conversion of the gathered related information, the formatted related information is forwarded to a device interface 140 of the management node 110. The device interface 140 is configured to provide a communication interface with a hand-held device 150. The hand-held device 150 may be a personal digital assistant, an electronic organizer, a wireless 2-way pager, a hand-held computer, etc., compatible with PALM OS, POCKET PC, or similar hand-held operating system.

The hand-held device 150 is configured to receive information related to a diagnosis and/or repair of the network error event, i.e., repair information. The repair information may include text notes from the network manager diagnosing and/or repairing the network error event, suggestions for enhancements for a network, modifications to network wiring diagrams, and the like.

The NMS 120 is further configured to synchronize the repair information with the repair message in response to docking the hand-held device 150 with the management node 110 at the device interface 140 after a diagnosis and/or repair of a network event. The NMS 120 correlates the repair information with the repair message to update a status of the repair message, to update network wiring diagrams and databases, and the like. Accordingly, a network manager may be provided the related information regarding a network error event in a hand-held device from a network management software to facilitate the diagnosis and/or repair of the network error event thereby reducing the time of repair of network error events.

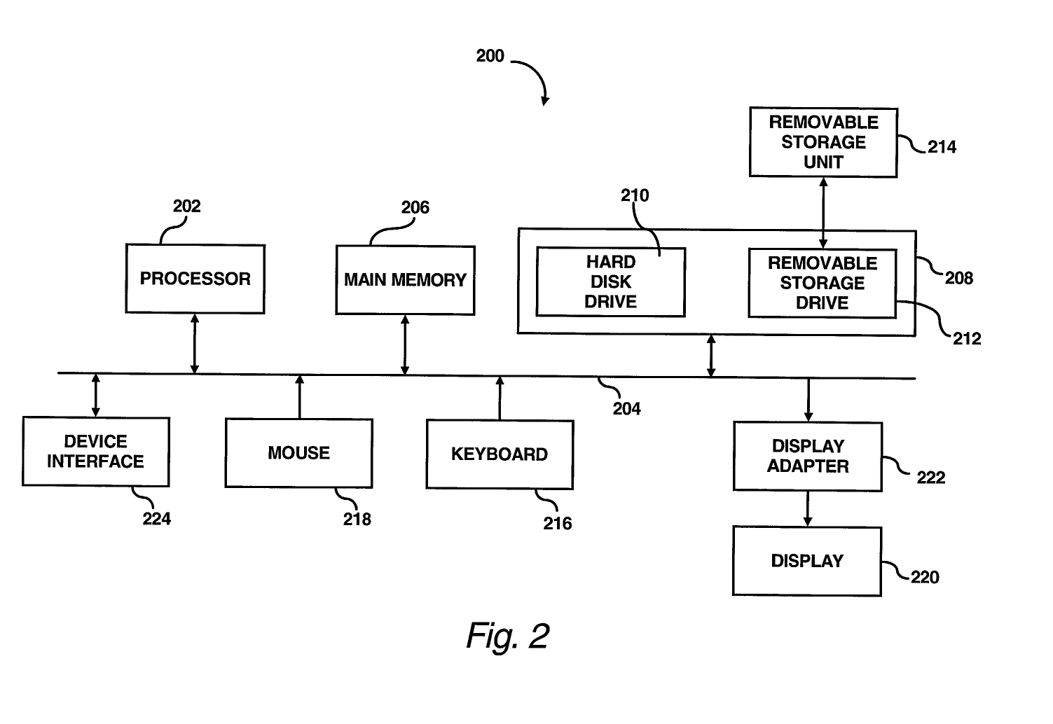

FIG. 2 illustrates a more detailed block diagram of an exemplary computer system 200 hosting a management node. The computer system 200 may be personal computer, a workstation, a client, and the like. Aspects of the present invention, at least the NMS, are embodied in computer program code and executed by the computer system 200.

In particular, the computer system 200 includes one or more processors, such as processor 202 that provides an execution platform for a network management software. Commands and data from the processor 202 are communicated over a communication bus 204. The computer system 200 also includes a main memory 206, preferably Random Access Memory (RAM), where the software for the network management software 110 is executed from during runtime, and a secondary memory 208. The secondary memory 208 includes, for example, a hard disk drive 210 and/or a removable storage drive 212, e.g., a floppy diskette drive, a magnetic tape drive, a compact disk drive, etc., where a copy of software for the NMS. The removable storage drive 212 reads from and/or writes to a removable storage unit 214 in a well-known manner. A user interfaces with the NMS with a keyboard 216, a mouse 218, and a display 220. The display adaptor 222 interfaces with the communication bus 204 to receive display data from the processor 202 and convert the display data into display commands from the display 220. The NMS may be further configured to interface with a hand-held device through a device interface 224.

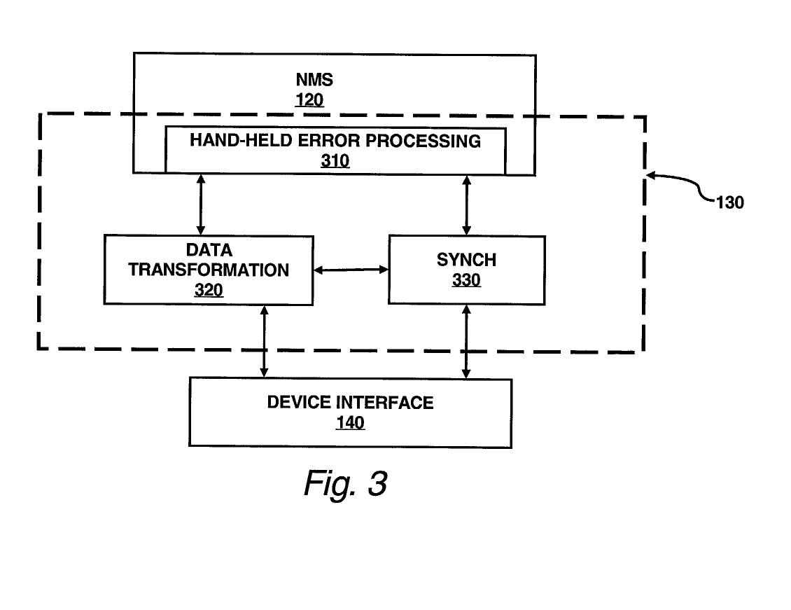

FIG. 3 illustrates a more detailed block diagram of a software architecture of an embodiment of the present invention. As shown in FIG. 3, the NMS 120 is configured to interface with the hand-held formatter 130. The hand-held formatter 130 includes at least a hand-held error processing module 310, a data transformation module 320, and a synchronization module 330.

The hand-held error-processing module 310 is configured to gather the related information of a network error event for a hand-held device 150. The hand-held error-processing module 310 is further configured to provide a graphical user interface for a network manager to select the types of related information to be gathered. The hand-held error-processing module 310 is further configured to receive repair information updates from a hand-held device 150 and to update the repair message with the repair information.

The data transformer module 320 is configured to provide a conversion between the information format of the NMS 120 and a hand-held data format of the hand-held device 150.

The synchronization module 330 is configured to ensure information transferred between the NMS 120 and the hand-held device 150 remains updated, i.e., synchronized. In effect, the synchronization module 330 ensures that if a network manager updates the handheld device 150 with repair information, the repair information is automatically transferred to the NMS 120. Conversely, if the NMS 120 has updated information for the related information of the network error event, the synchronization module 320 updates the previously transferred related information with the updated information. The synchronization module 330 is further configured to initiate a synchronization function in response to a detection of a presence of the hand-held device 150 on the device interface 140.

The hand-held data formatter 130 is further configured to interface with the device interface 150. The hand-held data formatter 130 may be part of the application interface (“API”), a daemon process, a software utility, or the like.

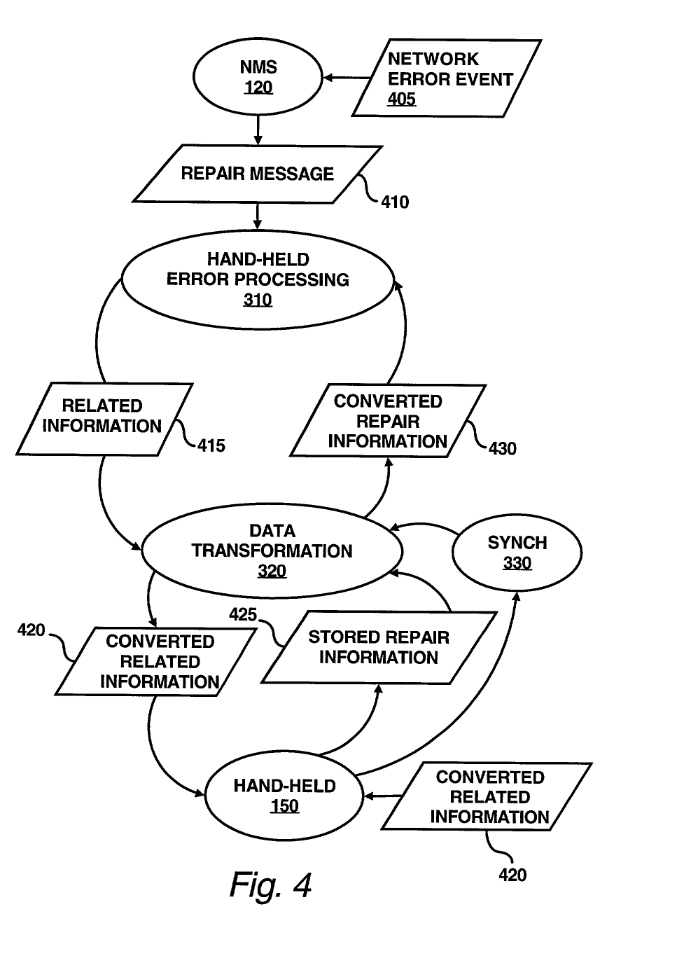

FIG. 4 illustrates an exemplary embodiment of a data flow diagram of the hand-held data formatter as shown in FIG. 3. In particular, the NMS 120 may receive a repair message in response to a network error event 405. The network manager (or user) may elect to convert the related information of the network error event into a hand-held device data format by initiating a command. The NMS 120 may forward the received repair message 410 to the hand-held error processing module 310 to gather the related information as selected by the network manager. The hand-held error-processing module 310 may be configured to forward the gathered related information 415 to the data transformation module 320 for conversion to a hand-held device data format. The converted related information 420 is transferred to a hand-held device 150.

The hand-held device 150 may be configured to receive repair information 420 from the network manager while the network manager is assessing and/or repairing the network error event. The repair information is stored temporarily in an allocated memory space of the hand-held device 150. The stored repair information 425 is transferred to the data transformation module 320 in response to a detection of the hand-held device 150 on the device interface 140 by the synchronization module 330. The stored information is converted into a data format of the NMS 120 by the data transformation module 320 and transferred to the hand-held error-processing module 310 of the hand-held data formatter 130. The handheld error-processing module 310 may be further configured to update the repair message and/or appropriate databases of the NMS 120 with the converted repair information 430.

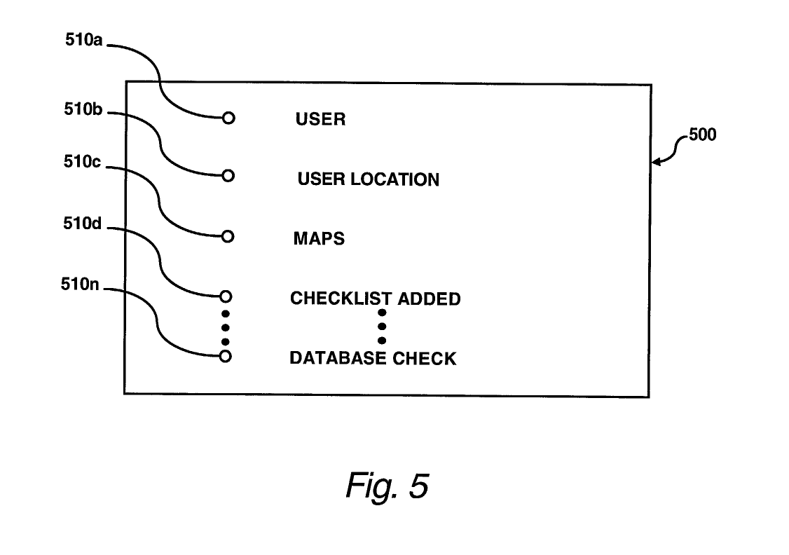

FIG. 5 illustrates an exemplary embodiment of a user interface 500 of the NMS to select the types of related information to be transferred. The NMS 120 may be configured to display the user interface 500 for a network manager to select the types of related information to gather in response to a parsing of a repair message. The user interface 500 may be a dialog box, a menu bar selection of the NMS 120, etc.

In particular, the user interface 500 provides a plurality of selection boxes 510a ... 510n, each selection box corresponding with a type of related information. If a user enables selection box 510a, the NMS 120 may access a database to retrieve the name of a reporting user of a repair message in preparation for transferring the name of the user to the hand-held device 150.

If a user enables selection box 510b, for example, the NMS 120 may access a database to retrieve a location of the reporting user in preparation for transferring the name of the user to the hand-held device 150.

If a user enables selection box 510c, for example, the NMS 120 may access a database to retrieve network-wiring diagrams, i.e., maps, around the reporting user in preparation transferring the name of the user to the hand-held device 150. The maps may be linked together through hypertext to give the user easier method of navigating through the maps. The maps may be images in a graphic format such as JPEG, GIF, etc. The linked-maps are gathered to in preparation for transfer to the hand-held device 150.

If a user enables selection box 510d, for example, the NMS 120 may access a database to retrieve checklists that describe possible steps in diagnosing and/or repairing the reported network error event in preparation transferring the name of the user to the hand-held device 150.

If a user enables selection box 510n, for example, the NMS 130 may access a database to cross-reference if the reported network error event has occurred previously. If the reported network error event had occurred, the repair information is retrieved in preparation transferring the name of the user to the hand-held device 150.

Although FIG. 5 depicts five types of related information, it is to be understood that the present invention is not limited to possessing five types, but rather, the user interface of the present invention may include any reasonable number of types. Accordingly, the five types of related information depicted in FIG. 5 provide only an illustration of the present invention and thus is not meant to limit the present invention in any respect.

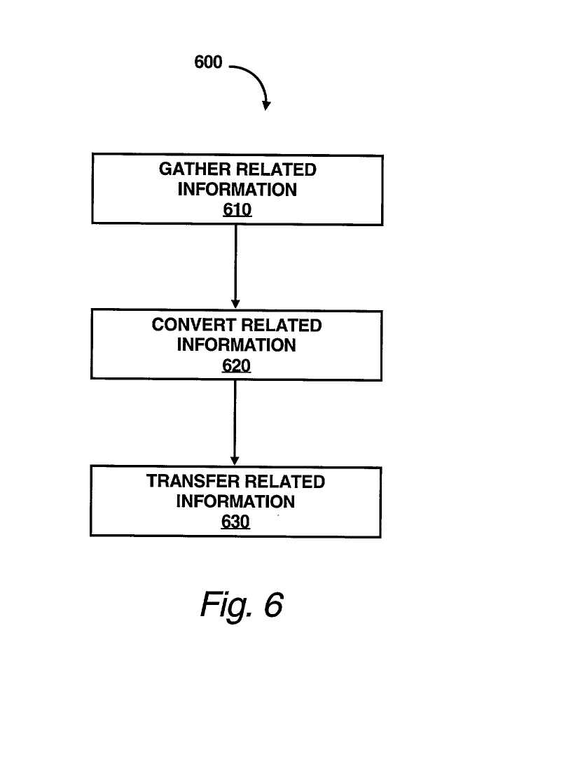

FIG. 6 illustrates an exemplary flow diagram 600 of a download operation in accordance with the principles of the present invention. In step 610, the NMS 120 gathers the related information of a network error event in response to receiving a repair message. The NMS 120 gathers the types of related information according to the selection boxes enabled by a network manager (see FIG. 5). The NMS 120 may store the related information in a memory space allocated for temporary storage in the memory 206 of the computer system 200. Alternatively, the related information may be stored as a file in the hard disk drive 210 of the computer system 200 (see FIG. 2).

In step 620, referring to FIG. 3, the NMS 120 forwards the related information to the data transformer module 310 of the hand-held data formatter 130 in response to a command from a network manager. The data transformer module 310 is configured to convert the related information in a NMS data format into a hand-held data format. The present invention contemplates supporting at least the PALM OS and POCKET PC for hand-held data formats. However, it is to be understood that the present invention is not limited to PALM OS and POCKET PC, but rather, the data transformation module 310 of the present invention may support other hand-held operating systems. Subsequently, in step 630, the data transformer module 320 forwards the formatted related information to a detected handheld device 150.

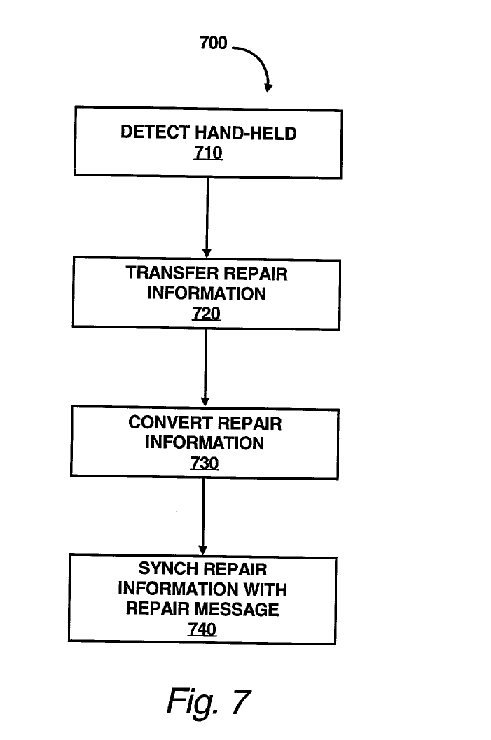

FIG. 7 illustrates an exemplary flow diagram 700 of a synchronization operation of an embodiment of the present invention shown in FIG. 3. In particular, in step 710, the synchronization module 330 of the hand-held data formatter 130 may detect the presence of the hand-held device 150 at the device interface 140.

If the hand-held device 150 is detected, the synchronization module 330 of the handheld data formatter 120 initiates a transfer of updated repair information to the NMS 120, in step 720.

In step 730, the data transformation module 310 of the hand-held data formatter 130 converts the updated repair information from a data format of the hand-held device 150 to a data format of the NMS 120.

In step 740, the synchronization module 320 of the hand-held data formatter 130 may be configured to interface with the NMS 120 to update the repair message with the updated repair information. Accordingly, the NMS 120 may update the status of the repair message for the network manager without manual input.

While the invention has been described with reference to the exemplary embodiments thereof, those skilled in the art will be able to make various modifications to the described embodiments of the invention without departing from the true spirit and scope of the invention. The terms and descriptions used herein are set forth by way of illustration only and are not meant as limitations. In particular, although the method of the present invention has been described by examples, the steps of the method may be performed in a different order than illustrated or simultaneously. Those skilled in the art will recognize that these and other variations are possible within the spirit and scope of the invention as defined in the following claims and their equivalents.

What is claimed is:

1. A method for assisting network management, comprising:
parsing a received repair message;
gathering related information in response to said parsing;
formatting said related information according to a hand-held data format into a formatted related information in response to a command; and
transferring said formatted related information to a hand-held device.

2. The method for assisting network management according to claim 1, further comprising:
receiving repair information from a hand-held device;
converting said repair information into a network management software data format; and
updating said repair message with repair information in response to a synchronization event.

3. The method for assisting network management according to claim 2, wherein said hand-held device comprises a personal digital assistant.

4. The method for assisting a network management according to claim 2, wherein said hand-held device comprises a pager..

5. The method for assisting network management according to claim 2, wherein said related information comprises recorded network faults within a user-defined time period of said repair message.

6. The method for assisting network management according to claim 2, further comprising:
generating a plurality of graphic images of a portion of said related information; and
creating at least one graphical link between each graphic image of said plurality of graphic images, wherein said plurality of graphical images is included in said hand-held related information.

7. The method for assisting network management according to claim 6, further comprising:
providing a plurality of categories of related information; and
selecting at least one category of related information gathered in response to said parsing of said repair message.

8. A computer readable storage medium on which is embedded one or more computer programs, said one or more computer programs implementing a method for assisting network management, said one or more computer programs comprising a set of instructions for:
parsing a received repair message;
gathering related information in response to said parsing;
formatting said related information into a hand-held related information in response to a command; and
transferring said hand-held related information to a hand-held device.

9. The computer readable storage medium in according to claim 8, said one or more computer programs further comprising a set of instructions for:
inputting repair information into said hand-held device;
transferring said repair information; and
updating said repair message with repair information in response to a synchronization of said held-held device.

10. The computer readable storage medium in according to claim 9, said one or more computer programs further comprising a set of instructions for:
providing a graphical user interface for a user to select a plurality of types of information to be gathered in response to said parsing; and
selecting at least one type of information.

11. The computer readable storage medium in according to claim 10, said one or more computer programs further comprising a set of instructions for:
generating a plurality of graphic images of a portion of said related information; and
creating at least one graphical link between each graphic image of said plurality of graphic images, wherein said plurality of graphical images is included in said hand-held related information.

12. The computer readable storage medium in according to claim 11, said one or more computer programs further comprising a set of instructions for:
providing a plurality of categories of related information; and
selecting at least one category of related information gathered in response to said parsing of said repair message.

13. The system for assisting network management comprising:
at least one processor;
a memory coupled to said at least one processor; and
a hand-held data formatter residing in said memory and executed by said at least one processor, wherein said hand-held data formatter is configured to gather related information in response to parsing a received repair message and to format said related information into a hand-held related information in response to a command.

14. The system for assisting network management according to claim 13, wherein said hand-held data formatter is further configured to transfer said hand-held related information to a hand-held device.

15. The system for assisting network management according to claim 14, wherein:
said hand-held data formatter is further configured to receive repair information form said hand-held device, whereby said repair information is inputted into said hand-held device.

16. The system for assisting network management according to claim 15 wherein:
said hand-held data formatter is further configured to update said repair message with repair information in response to a synchronization of said held-held device.

17. The system for assisting network management according to claim 14, wherein said hand-held device comprises a personal digital assistant.

18. The system for assisting network management according to claim 14, wherein said hand-held device comprises a pager.
